(19) United States
(12) Patent Application Publication
(10) Pub. No.: US 2004/0212846 A1
(43) Pub. Date: Oct. 28, 2004

(54) Interleaved image processing for an imaging apparatus

(76) Inventors: Christopher N. Baunach, Bardstown, KY (US); Scott T. Cramer, Lexington, KY (US); Stuart W. Daniel, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/424,055

(22) Filed: Apr. 25, 2003

(51) Int. Cl. H04N 1/40; G06F 9/28

(52) U.S. Cl. 358/471; 382/304

(57) ABSTRACT

An imaging apparatus and method for a single-pass, duplex-capable scanner having increased simplex scanning speed. The imaging apparatus has a first image reading element, a first image processing component, and a second image processing component. When the imaging apparatus is in a simplex mode, a data switch is configured to alternately pass image data acquired through the first image reading element to the first image processing component and the second image processing component.

### FIELD OF THE INVENTION

Embodiments of the present invention relate generally to imaging apparatuses, and more specifically, to methods and systems for increased throughput in simplex scanning with an imaging apparatus having multiple image processors.

### BACKGROUND OF THE INVENTION

Current digital copier architectures typically implement a single image processing component (e.g., an image processor) capable of supporting the full system throughput. As image scanning speeds and resolutions increase, however, finding an image processing component that can keep up with the amount of information generated by a high-speed, high-resolution scanner becomes both difficult and expensive. As such, the scanning speed is typically limited by the processing speed of the image processing component. Accordingly, the image processing component has become a primary bottleneck in such imaging apparatuses.

In a single-pass duplex scanner, two separate image processing components are typically provided, each devoted to handling the image processing requirements for a corresponding image reading element (e.g., an image reader). FIG. 1 shows the main data path for such a single-pass, duplex scanner 20, such as the Lexmark Optra 443, for example. Typically, scanner 20 comprises a first image reader (e.g., front image reader 25) and a second image reader (e.g., back image reader 35).

In order to process the data from the two separate image reading elements (image readers 25 and 35) simultaneously, the scanner incorporates two respectively corresponding image processing components (image processors 30 and 40). The processed image from the first image processor 30 and the second image processor 40 are then stored together in memory and obtained by the client interface 45. However, when the scanner is in a simplex mode, the back side image reading element and the corresponding image processing component are not utilized.

### SUMMARY OF THE INVENTION

In one embodiment, an imaging apparatus and method for increased simplex scanning with a duplex capable scanner having multiple image processors is provided.

One embodiment of the present invention is an imaging apparatus including a first image reading element, a first image processing component, and a second image processing component; wherein when the imaging apparatus is in a simplex mode, image data acquired through the first image reading element is alternately passed to the first image processing component and the second image processing component.

Another embodiment of the present invention comprises a method for increased simplex scanning speed in a scanner having multiple image processing elements. The method comprises scanning document pages utilizing an image reading element, generating image data corresponding to each of the document pages scanned by the image reading element, and alternately passing the image data to a first image processing component and a second image processing component.

Another embodiment of the present invention is an imaging apparatus for simplex and duplex scanning, wherein the imaging apparatus has increased scanning speed when in a simplex mode. The imaging apparatus comprises a first image reading element; a second image reading element; a first image processing component; a second image processing component; a multiplexer; and a data switch. When the imaging apparatus is in a simplex mode, the data switch is configured to alternately pass image data acquired through the first image reading element to the first image processing component and the multiplexer, wherein the multiplexer is in communication with the second image processing component. When the imaging apparatus is in a duplex mode, the data switch is configured to pass image data acquired through the first image reading element to the first image processing component, and the multiplexer passes image data acquired through the second image reading element to the second image processing component.

Another embodiment of the present invention is a single-pass duplex imaging apparatus. The imaging apparatus comprises a first image reading element; a second image reading element; a first image processing component; a second image processing component; a demultiplexer having an input and an output, wherein the input is in data communication with the first image reading element; and a multiplexer having an input and output, wherein the output is in data communication with a second image processing component. When the imaging apparatus is in a simplex mode, the second image reading element is disabled and the demultiplexer is configured to alternately pass image data acquired through the first image reading element to the first image processing component and the input of the multiplexer.

Another embodiment of the present invention is a computer data signal embodied in a carrier wave and representing sequences of instructions which, when executed by a processor, control an image processing path for a simplex imaging operation on a single-path, duplex-capable imaging device, by the following act: scanning a document utilizing an image reading element; generating image data corresponding to the document scanned by the image reading element; and alternately passing the image data to a first image processing component and a second image processing component.

Another embodiment of the present invention is a computer program product, comprising: a computer usable medium having computer readable code embodied thereon capable of increasing simplex scanning speed in a scanner having multiple image processing components, comprising: a code portion configured to scan a document utilizing an image reading element; a code portion configured to generate image data corresponding to the document scanned by the image reading element; a code portion configured to alternately pass the image data to a first image processing component and a second image processing component.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a schematic illustration of an exemplary duplex scanning image data path of the prior art;

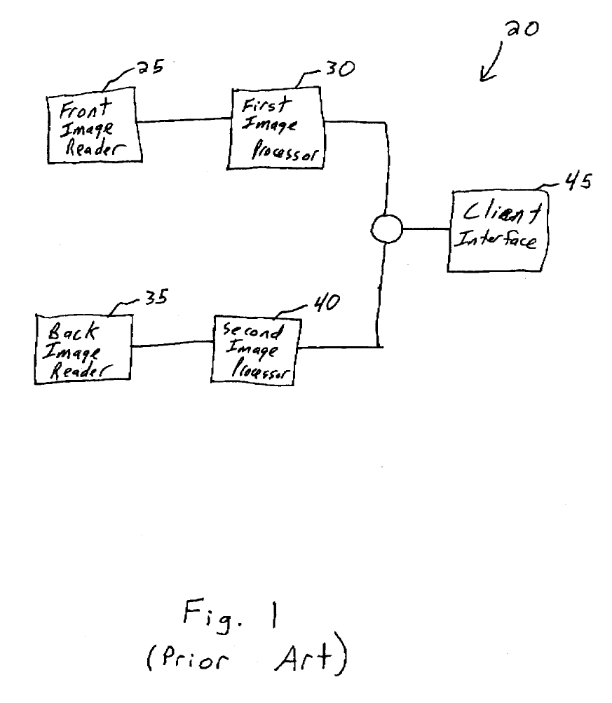

FIG. 2 is a schematic illustration of an exemplary imaging apparatus for practicing one embodiment of the present invention;

FIG. 3 is a schematic illustration of an exemplary image data path of an imaging apparatus of the present invention; and

FIG. 4 is a schematic illustration of an exemplary image data path of an imaging apparatus of the present invention.

The embodiments set forth in the drawings are illustrative in nature and are not intended to be limiting of the invention defined by the claims. Moreover, individual features of the drawings and the invention will be more fully apparent and understood in view of the detailed description.

### DETAILED DESCRIPTION

Reference will now be made in detail to various embodiments of the invention, examples of which are illustrated in the accompanying drawings, wherein like numerals indicate similar elements throughout the views.

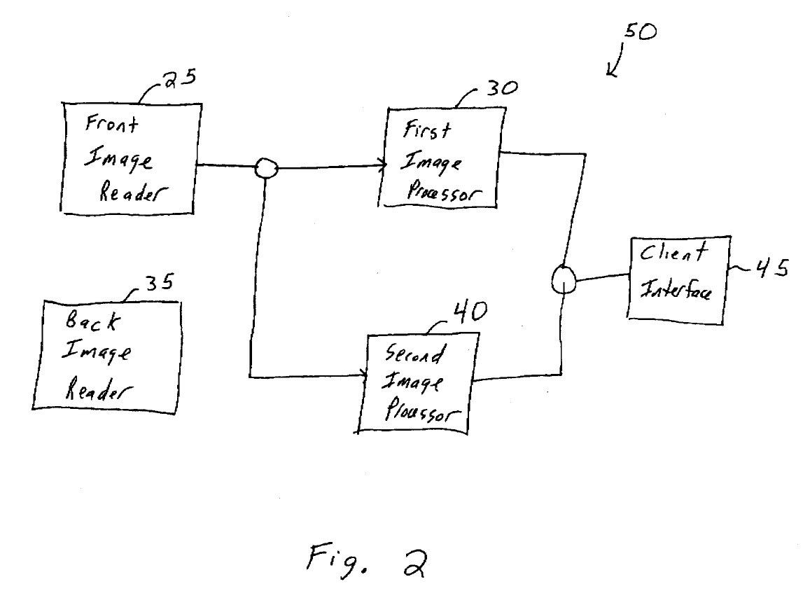

One embodiment of the invention is depicted in FIG. 2. FIG. 2 illustrates an exemplary image data path 50 of an imaging apparatus of the present invention. When the image apparatus is in a simplex mode, the back image reader 35 is turned off or not utilized. The front image reader 25 is utilized to acquire image data regarding every page in the simplex operation. The image data is alternately passed to the first image processor 30 and the second image processor 40. This allows increased scanning speed to be utilized as the scanning speed does not have to wait for the first image processor to finish processing data corresponding to the first page. For example, while the first image processor 30 is finishing the processing of the first page, the front image reader 25 can scan the second page and the corresponding image data can be passed to the second image processor 40. This process (alternately passing acquired image data to the two image processing components) continues until all of the pages have been scanned.

The image reader or image scanning element can comprise any image reading/scanning technology known to one skilled in the art. For example, the image reader 25 may comprise a charge coupled device (CCD) for recording of an image. The CCD is an array of a large number of light sensitive elements connected to each other as an analog shift register. In each element of the CCD, a charge is formed that is proportional to the light energy incident on the element during an integration period. The analog charge of each element is shifted serially out of the CCD and processed by an image processor (30 and 40). Typically, the analog charges are converted to digital values whereby a digital representation of the scanned image is formed. The digital values may be further processed by signal processing hardware and software of the signal processing electronics before transmission to external equipment through an interface.

Typically, the CCD of the imaging apparatus is a linear CCD in which the light-sensing elements are arranged in a single line. During scanning, the original is moved relative to the CCD array and the original is scanned one line at a time. For color scanning, a trilinear CCD array, which comprises three linear CCD's positional side by side, can be utilized. Typically, each line of the trilinear CCD array is covered by its own color filter, typically in the form of a dye that is painted over the elements.

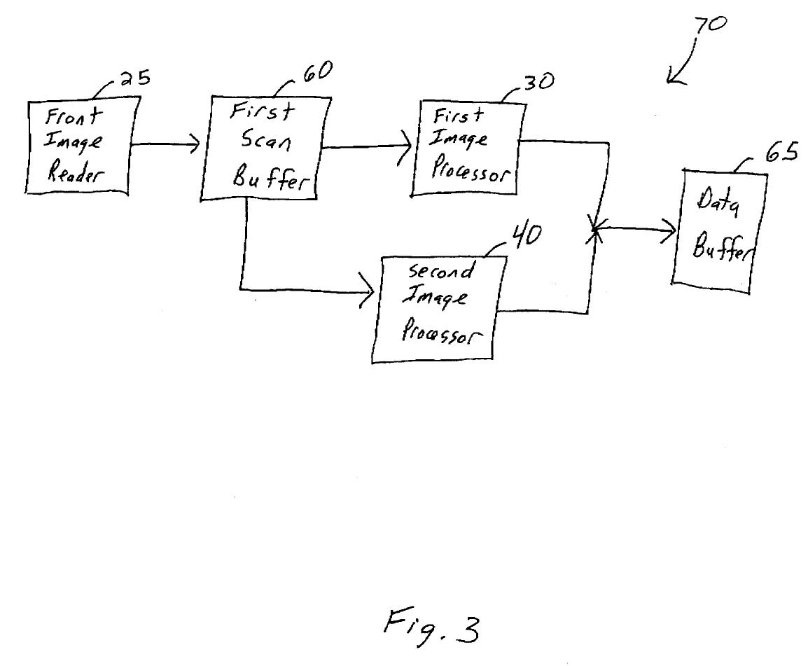

FIG. 3 depicts another embodiment of the present invention. In this embodiment, the image data path 70 of the imaging apparatus while in a simplex mode comprises: a front image reader 25 that is utilized to acquire image data for all the pages in the scan job. The image data acquired through the first imager reader 25 is stored in a scan buffer 60. The first image processor 30 and the second image processor 40 alternately read out the image data stored in the first scan buffer 60. After processing the image data, the processed image data is passed to and stored in a data buffer 65. In one embodiment, the data buffer 65 may be the same data buffer as the scan buffer 60. The client application can retrieve the processed image data from the data buffer 65 for further processing and utilization.

One embodiment of the present invention is an imaging apparatus comprising a front image reading element 25; a first image processing component 30; a second image processing component 40 and a data switch in communication with the front image reading element 25. The data switch may comprise hardware or software, contained in the front image reader 25 or in a separate component in the data path of the imaging apparatus. When the imaging apparatus is in a simplex mode, the data switch is configured to alternately pass image data acquired through the front image reading element 25 to the first image processing component 30 and the second image processing component 40.

In one embodiment of the present invention, the imaging apparatus further comprises a second image reading element 35. When the imaging apparatus is in a duplex mode, the data switch is configured to pass image data acquired through the front image reading element 25 to the first image processing component 30 and to pass image data acquired through the second image reading element 35 to the second image processing component 40.

Another aspect of the present invention is a method for increased simplex scanning speed in a scanner having multiple image processing components. The method comprises sending instructions to scan a document utilizing the image reading element 25. Image data acquired through the front image reader 25 corresponding to the documents scanned by the image reading element is passed to either the first image processor 30 or the second image processor 40.

In one embodiment, the data path to the first image processor 30 and the second image processor 40 is controlled by software and/or hardware. For example, front image reader 25 may comprise a controller having executable instructions directing image data acquired through the image reader 25 to be alternately sent along two data paths to the first and second image processors (30 and 40). In another embodiment, a data switch or gate may control the path of all the image data acquired through the front image reader 25.

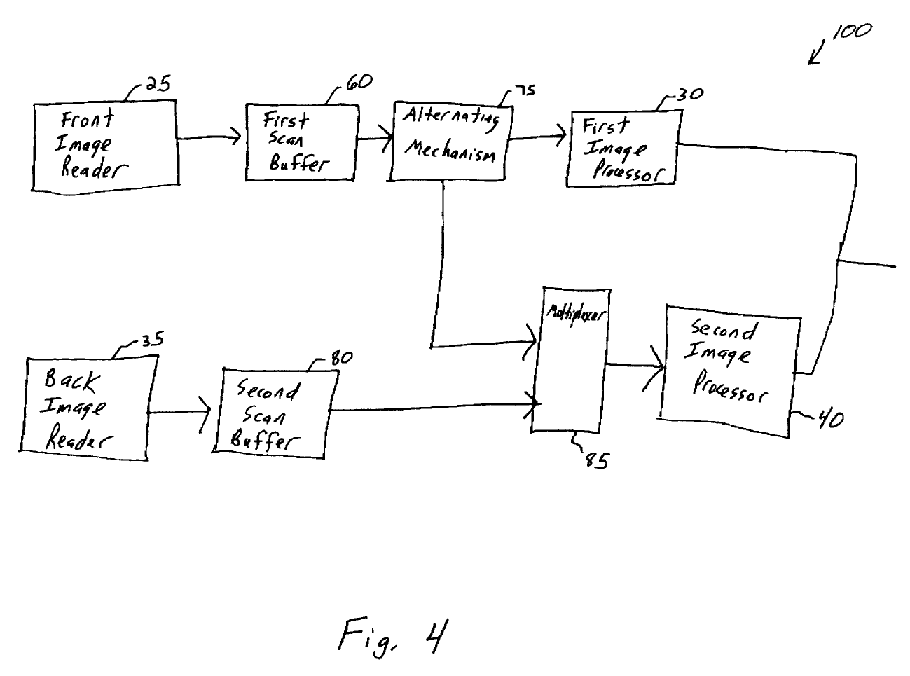

FIG. 4 depicts another exemplary embodiment of the present invention relating to an imaging apparatus for simplex and duplex scanning, wherein the imaging apparatus has increased scanning speed when in a simplex mode. The imaging apparatus data path 100 comprises a front image reading element 25; a back image reading element 35; a first image processing component 30; a second image processing component 40; a multiplexer 85; and a data switch/demultiplexer 75. When the imaging apparatus is in a simplex mode, the data switch/ demultiplexer 75 is configured to alternately pass image data acquired through the front image reading element 25 to the first image processing component 30 and the multiplexer 85. The multiplexer 85 is in communication with the second image processing component 40. When the imaging apparatus is in a duplex mode, the data switch 75 is configured to pass image data acquired through the front image reading element 25 to the first image processing component 30, and the multiplexer 85 is configured to pass image data acquired through the second image reading element 35 to the second image processing component 40.

In one embodiment, the imaging apparatus further comprises a first scan buffer 60 and a second scan buffer 80. The first scan buffer 60 is in communication with the front image reader 25 and the data switch/demultiplexer 75. Image data acquired through front image reader 25 is stored in the first scan buffer 60. The image data is then read out from the first scan buffer 60 by the data switch/demultiplexer 75.

In a duplex mode, the data switch/multiplexer 75 passes the image data acquired through the front image reader 25 to the first image processor 30. Whereas, when in a simplex mode, the data switch/multiplexer 75, alternates the image data acquired through front image reader 25 between first image processor 30 and second image processor 40 by way of the multiplexer 85.

Another aspect of the present invention is a computer data signal embodied in a carrier wave and representing sequences of instructions which, when executed by a processor, control an image processing path for a simplex imaging operation on a single-pass, duplex-capable imaging device, by the following act: scanning a document utilizing an image reading element; generating image data corresponding to the document scanned by the image reading element; and alternately passing the image data to a first image processing component and a second image processing component.

Another aspect of the present invention is a computer program product. The computer program product comprises a computer usable medium having computer readable code embodied therein capable of increasing simplex scanning speed in a scanner having multiple image processing components, comprising: a code portion configured to send instructions to a data switch, wherein the instructions are configured to alternate an image data stream between a first image processing component and a second image processing component; a code portion configured to scan a document utilizing an image reading element; a code portion configured to generate image data corresponding to the document scanned by the image reading element; and a code portion configured to pass the image data to a data switch, wherein the data switch alternates passing the image data to a first image processing component and a second image processing component.

By utilizing multiple image processors when in a simplex mode, a scanner can have increased throughput in situations where the image processor is typically the bottleneck. This allows launching the next page of a scanning job as soon as the current page's data has been transferred to the scanner buffer, but before the active image processor is finished processing that data. The data for the next page will be routed through the other idle image processor. In one embodiment, the scanner also includes a mechanism to notify the client when a physical scan of a page has been completed so that the next page can be launched through the idle image processor while the active image processor finishes processing data from the first page. Moreover, in another embodiment, when no off-the-shelf image processor capable of producing a desired throughput is practical, two image processors that are individually incapable of producing the desired throughput can be used.

The foregoing description of the various embodiments of the invention has been presented for the purposes of illustration and description. It is not intended to be exhaustive or limit the invention to the precise form disclosed. Many alternatives, modifications and variations will be apparent to those skilled in the art of the above teaching. Accordingly, this invention is intended to brace all alternatives, modifications and variations that have been discussed herein, and others that fall within the spirit and broad scope of the claims.

What is claimed:

1. An imaging apparatus, comprising:
a first image reading element;
a first image processing component;
a second image processing component; and
wherein when the imaging apparatus is in a simplex mode, the imaging apparatus is configured to alternately pass image data acquired through the first image reading element to the first image processing component and the second image processing component.

2. The imaging apparatus of claim 1, further comprising:
a second image reading element;
wherein when the imaging apparatus is in a duplex mode, the imaging apparatus is configured to pass image data acquired through the first image reading element to the first image processing component and to pass image data acquired through the second image reading element to the second image processing component.

3. The imaging apparatus of claim 1, further comprising a data switch in communication with the first image reading element, wherein the data switch is configured to alternately pass image data acquired through the first image reading element to the first image processing component and the second image processing component.

4. The imaging apparatus of claim 1, further comprising a data buffer, wherein the data buffer is in communication with the first image reading element, and the data buffer is configured to store the image data acquired through the first image reading element, and further wherein the imaging apparatus is configured to alternately pass the image data stored in the data buffer to the first image processing component and the second image processing component.

5. A method for increased simplex scanning speed in a scanner having multiple image processing components, comprising:
scanning document pages utilizing an image reading element;
generating image data corresponding to each of the document pages scanned by the image reading element; and
alternately passing the generated image data to a first image processing component and a second image processing component.

6. The method of claim 5, wherein the act of alternately passing the image data to a first image processing component and a second image processing component comprises:
passing the generated image data through a data switch in communication with the image reading element, wherein the data switch is configured to alternate passing the image data to the first image processing component and the second image processing component.

7. The method of claim 5, further comprising storing the generated image data in a data buffer;
wherein the data buffer is in communication with the first image processing component and the second image processing component.

8. The method of claim 5, wherein the act of alternately passing the generated image data to a first image processing component and a second image processing component further comprises alternately passing the generated image data to a first image processing component, a second image processing component, and a third image processing component.

9. An imaging apparatus for simplex and duplex scanning, wherein the imaging apparatus has increased scanning speed when in a simplex mode, comprising:
a first image reading element;
a second image reading element;
a first image processing component;
a second image processing component;
a multiplexer; and
a data switch;
wherein when the imaging apparatus is in a simplex mode, the data switch is configured to alternately pass image data acquired through the first image reading element to the first image processing component and the multiplexer, wherein the multiplexer is in communication with the second image processing component; and
wherein when the imaging apparatus is in a duplex mode, the data switch is configured to pass image data acquired through the first image reading element to the first image processing component, and wherein the multiplexer passes image data acquired through the second image reading element to the second image processing component.

10. A single-pass duplex imaging apparatus, comprising:
a first image reading element;
a second image reading element;
a first image processing component;
a second image processing component;
a demultiplexer, having an input and output, wherein the input is in data communication with the first image reading element; and
a multiplexer, having an input and output, wherein the output is in data communication with the second image processing component; and
when the imaging apparatus is in a simplex mode, the second image reading element is disabled and the demultiplexer is configured to alternately pass image data acquired through the first image reading element to the first image processing component and the input of the multiplexer.

11. The imaging apparatus of claim 10, wherein when the imaging apparatus is in a duplex mode, the second image reading element is enabled and the multiplexer passes image data acquired through the second image reading element to the second image processing component, and wherein the demultiplexer passes image data acquired through the first image reading element to the first image processing component.

12. A computer data signal embodied in a carrier wave and representing sequences of instructions which, when executed by a processor, control an image processing path for a simplex imaging operation on a single-pass, duplex-capable imaging device, by the following act:
scanning a document utilizing an image reading element;
generating image data corresponding to the document scanned by the image reading element; and
alternately passing the generated image data to a first image processing component and a second image processing component.

13. The computer data signal of claim 12, comprising instructions for passing the generated image data through a data switch in communication with the image reading element, wherein the data switch is configured to alternate passing the generated image data to the first image processing component and the second image processing component.

14. A computer program product, comprising:
a computer useable medium having computer readable code embodied therein capable of increasing simplex scanning speed in a scanner having multiple image processing components, comprising:
a code portion configured to scan a document utilizing an image reading element;
a code portion configured to generate image data corresponding to the document scanned by the image reading element;
a code portion configured to alternately pass the image data to a first image processing component and a second image processing component.

15. The computer program product of claim 14, further comprising:
a code portion configured to send instructions to a data switch wherein the data switch is in communication with the image reading element and further wherein the instructions are configured to alternate an image data stream between the first image processing component and the second image processing component.
